(19) United States
(12) Patent Application Publication
(10) Pub. No.: US 2025/0356030 A1
(43) Pub. Date: Nov. 20, 2025

(54) Secure Field Data Capture and AI-Assisted Asset Management System

(71) Applicants: Joshua A Wright, Wichita, KS (US); Wayne J Kaljumaa, Valley Center, KS (US)

(72) Inventors: Joshua A Wright, Wichita, KS (US); Wayne J Kaljumaa, Valley Center, KS (US)

(21) Appl. No.: 19/280,126

(22) Filed: Jul. 25, 2025

(51) Int. Cl. G06F 21/60; H04L 9/06

(52) U.S. Cl. CPC G06F 21/602; H04L 9/0631

(57) ABSTRACT

A secure field-data platform captures equipment images and engineering diagrams via mobile devices or autonomous platforms. On-device AI extracts asset nomenclature and nameplate data, prefilling records. A human-in-the-loop interface enables annotation, validation, and manual data entry. Data are encrypted (AES-256 or equivalent) and queued locally, then synchronized to a backend via secure transports. The system supports cryptographic agility, over-the-air AI model updates, and deployment in SaaS, on-premises, or air-gapped environments. Immutable audit logs ensure compliance. This invention enhances asset-management efficiency and security for utilities, industrial facilities, government agencies, and data centers.

### FIELD OF THE INVENTION

The present invention relates to industrial asset-management systems and, more particularly, to secure field-data capture, diagram ingestion, AI-assisted extraction, and compliance-driven synchronization of asset records for utilities, industrial facilities, government entities, data centers, and other critical-infrastructure operators worldwide.

### BACKGROUND OF THE INVENTION

Utilities, government entities, and industrial operators maintain vast inventories of physical assets-transformers, valves, pumps, server racks-tracked in disparate spreadsheets or outdated CMMS platforms. Field technicians often collect data offline in hazardous or connectivity-limited environments via handwritten notes or disconnected digital photographs, a process prone to transcription error rates that can range from 5-15%, depending on the context and complexity of the data, as noted in a systematic review by Kim et al. [4]. Existing cloud-only capture solutions, such as those offered by IBM Maximo or SAP Asset Manager, primarily rely on constant connectivity and often aim for full automation or provide only disconnected manual entry. These prior art systems lack:

Diagram-based prefill, which pre-populates asset inventories, significantly reducing manual effort.

Cryptographic agility for air-gapped environments, essential for national security needs and high-security installations.

An audit-ready correction workflow necessary for modern data governance, national security needs, and international compliance requirements, particularly one that seamlessly integrates AI-assisted extraction with a human-in-the-loop validation and adaptive learning mechanism.

Integrated AI-assisted extraction with air-gapped security, unlike general OCR solutions such as ABBYY FineReader, which focus on document processing without robust compliance features.

The present invention distinguishes itself by integrating on-device AI processing with a robust human-in-the-loop validation, cryptographic agility, and secure air-gapped synchronization, coupled with an immutable audit logging system, providing a uniquely comprehensive, accurate, and secure solution for critical infrastructure asset management, particularly where cloud-dependent solutions are non-viable or prohibited.

### SUMMARY OF THE INVENTION

Disclosed is a system that:

Captures engineering diagrams or photos.

Uses on-device AI to extract asset metadata.

Allows a human operator to confirm, correct, annotate, add missed assets, and map geolocation.

In some embodiments, enables intelligent bypass of human validation when inference confidence exceeds a configurable threshold, thereby optimizing field workflow efficiency, automatically encrypting and queuing prefilled asset data in the secure data queue module (114) for later synchronization (‘auto-queue’ mode).

Synchronizes encrypted data to a backend via cryptographically agile transports.

Supports SaaS, on-premises, and fully air-gapped environments, continuous encrypted backup, and over-the-air AI model upgrades.

Enables intelligent, highly secure data capture in no-connectivity environments, such as air-gapped or classified government facilities, adhering to stringent compliance frameworks.

### BRIEF DESCRIPTION OF THE DRAWINGS

FIG. 1—Depicts the overall system architecture block diagram, illustrating the interaction between the mobile field device, AI models, secure data queue, backend systems, and the Model Synchronization Module.

FIG. 2—Illustrates the secure capture-to-synchronization workflow diagram, detailing the stages of data acquisition, processing, and transmission.

FIG. 3—Illustrates the security pipeline, including immutable audit logging via hash-chaining, air-gapped data integrity measures, and a Compliance Adaptation Module for dynamic configuration based on regulatory standards.

FIG. 4—Shows various deployment options, including SaaS, on-premises, and air-gapped environments, demonstrating the system's flexibility.

FIG. 5—Provides a field workflow example, outlining the steps for asset data capture and management in a typical operational setting.

FIG. 6—Illustrates a domain-specific deployment of the system, detailing a data-center workflow and specifically showing how the system captures and processes server and equipment data in high-density, secure environments.

### DETAILED DESCRIPTION

### Definitions

Model Synchronization Module (119): Manages the consistency and versioning of AI models by comparing local models against a central registry and initiating secure updates.

Secure Data Queue Module (114): Temporarily stores collected data in an encrypted format (e.g., AES-256 or stronger), employing dynamic buffer allocation and data prioritization to manage extended local storage in air-gapped environments, ensuring data integrity during prolonged network unavailability or in intermittently connected environments.

Cryptographic Agility: The ability to seamlessly transition between cryptographic standards without system downtime, supporting NIST-approved algorithms including but not limited to AES-256, TLS 1.3, and post-quantum algorithms such as Kyber, ensuring future-proof security.

Compliance Adaptation Module (311): A module configured to dynamically select and apply cryptographic algorithms, audit logging parameters, data retention policies, or other system security settings based on a plurality of pre-defined or user-selected compliance frameworks, such as NERC-CIP, CMMC, GDPR, SOC 2, ISO 27001, and IEC 62443.

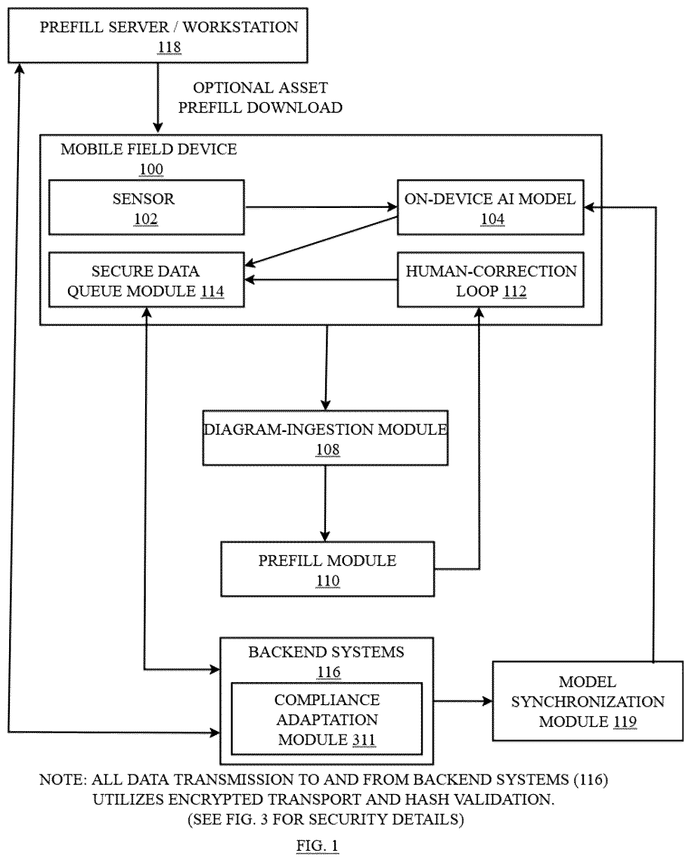

### System Overview (FIG. 1)

Referring to FIG. 1, the overall system architecture for secure field data capture and AI-assisted asset management is depicted. The system comprises a mobile field device (100) equipped with a sensor (e.g., camera or scanner) (102) and an on-device AI model (104). The diagram-ingestion module (108) accepts photos or uploaded CAD/PDF files to extract asset symbols and nomenclature. A prefill module (110) is configured to populate asset inventories. This module facilitates two primary prefill modes:

On-Device Prefill: where the mobile field device (100) directly performs diagram ingestion via its sensor (102) or uploaded files, and subsequently pre-populates asset inventories using its on-device AI model (104) and prefill capabilities (as claimed in claim 4).

Hybrid/External Prefill: where diagram ingestion and inventory pre-population occur on a dedicated Prefill Server/Workstation (118) (e.g., a workstation, remote server, or cloud platform), with the prefilled inventories then securely transmitted to mobile devices (as claimed in claim 10). The system includes a human-correction loop (112) for validation, and a secure data queue module (114) for storing encrypted data. Data is ultimately synchronized to Backend Systems (116), which are configured to receive this synchronized data, host central asset databases, manage AI model registries, and facilitate adaptive learning processes. These Backend Systems (116) can be deployed as a SaaS solution, on-premises, or in an isolated air-gapped environment. The Backend Systems (116) further include a Compliance Adaptation Module (311), which is configured to dynamically select and apply appropriate cryptographic algorithms, audit logging parameters, and other security settings based on specific compliance frameworks. Additionally, the Backend Systems (116) include a Model Synchronization Module (119), responsible for managing the consistency and versioning of AI models by comparing local device models (104) against a central backend registry and initiating secure updates. The system also incorporates edge computing optimizations (e.g., model compression, quantization) for resource-constrained devices like wearables or UAVs.

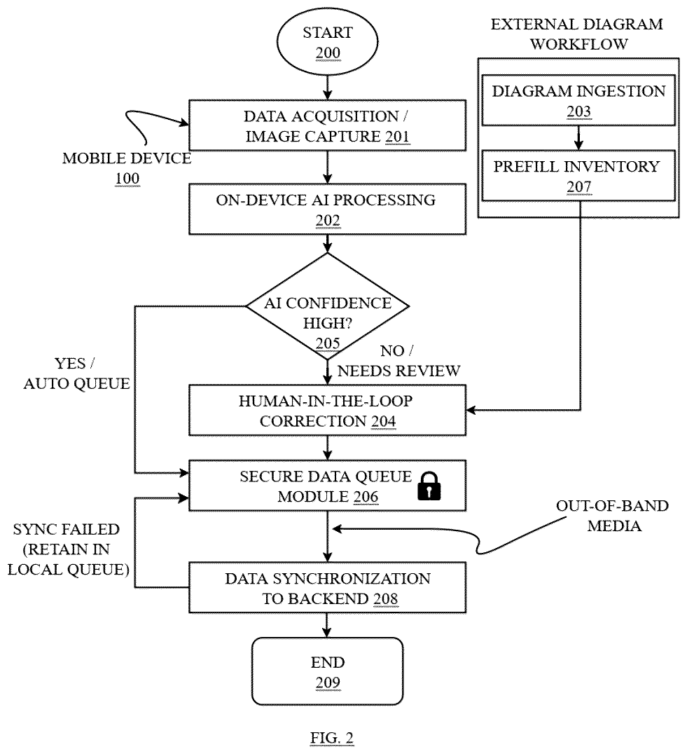

### FIG. 2—Secure Capture-to-Synchronization Workflow

FIG. 2 illustrates the secure capture-to-synchronization workflow. The process begins with Raw Data Capture (201), where data is acquired, for example, by the mobile field device (100) utilizing its sensor (102). This captured data then proceeds to On-Device AI Processing (202), where the on-device AI model (104) extracts initial asset information. Parallel to or as part of the initial data acquisition, the Diagram Ingestion (203) module (corresponding to 108) accepts engineering diagrams, which feed into the Prefill Inventory (207) step (corresponding to prefill module 110) to pre-populate asset details.

Following On-Device AI Processing (202) and Prefill Inventory (207), the system proceeds to a decision point (205) where it evaluates the AI's confidence in the extracted data and determines if human review is needed. If the AI confidence is high (e.g., meets a configurable threshold), the data bypasses human validation, automatically encrypting and queuing prefilled asset data in the secure data queue module (206) (corresponding to secure data queue module 114) for later Data Synchronization to Backend (208) (corresponding to Backend Systems 116). This represents the ‘auto-queue’ mode, as further described in claim 19. If the AI confidence is below a critical level, indicating a review is needed, the workflow directs the data to Human-in-the-Loop Correction (204) (corresponding to human-correction loop 112). After human correction, the data is then directed to the secure data queue module (206) before Data Synchronization to Backend (208). An optional error state, such as “Sync Failed,” can occur from Data Synchronization to Backend (208), returning data to Secure Data Queue Module (206) for retention in the local queue until synchronization can be re-attempted.

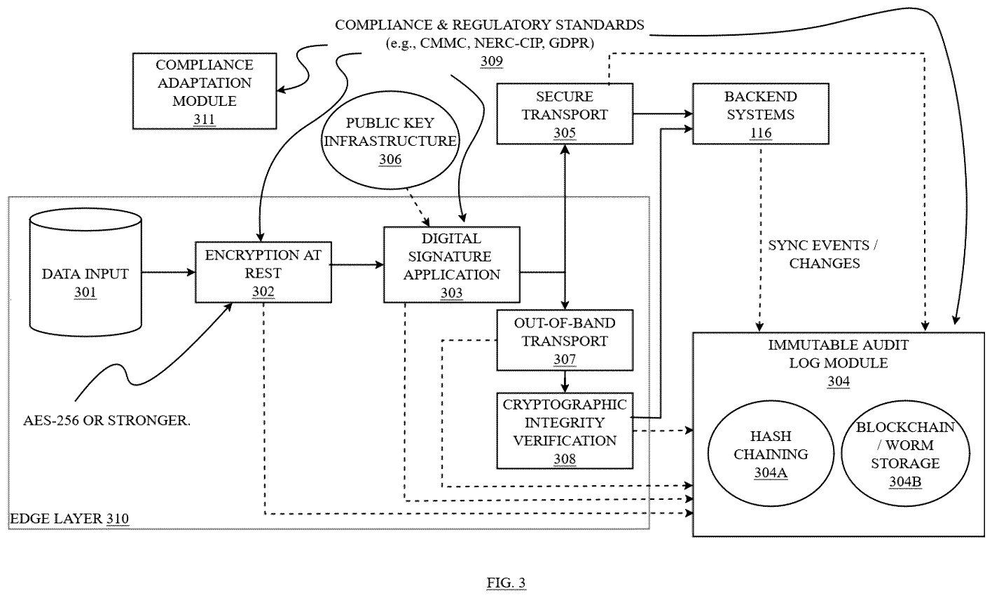

### FIG. 3—Security Pipeline

Referring now to FIG. 3, the security pipeline of the present system is illustrated, demonstrating the multi-layered approach to data protection and compliance. The initial stages of the pipeline occur within an Edge Layer (310), encompassing the data input and local security measures. Data entering the pipeline, such as Data Input (e.g., Raw/Captured Data) (301), first undergoes Encryption at Rest (302) (e.g., utilizing AES-256 or stronger standards) to protect data stored on the mobile device or within the secure data queue module (114). Following encryption, Digital Signature Application (303) is performed to ensure data provenance and integrity. This process is supported by the Public Key Infrastructure (PKI) (306) which manages cryptographic keys and certificates, enabling authentication and verification. All data access and modifications (including synchronization events from Backend Systems (116)), AI model update events, user authentication attempts, and system configuration changes are recorded by an Immutable Audit Log Module (304). Immutability within this module is enforced via mechanisms such as Hash-Chaining (304a) and redundant storage in Blockchain/WORM Storage (304b), as further detailed in claim 8. For synchronization to Backend Systems (116), two distinct secure transport paths are employed. For networked environments, data proceeds through Secure Transport (305) using secure protocols like TLS 1.3 or NIST-approved post-quantum cryptographic algorithms. For air-gapped deployments, data is transferred via Out-of-Band Transport (307) (e.g., removable media, data diodes, or secure wired links), and its integrity is ensured upon receipt through Cryptographic Integrity Verification (Hash Validation) (308). The entire security pipeline operates in adherence to various Compliance & Regulatory Standards (309), including but not limited to CMMC, NERC-CIP, GDPR, SOC 2, ISO 27001, and IEC 62443. This adherence is actively managed by a Compliance Adaptation Module (311) (integrated within Backend Systems 116), which dynamically configures the system's security posture. For instance, upon selection of a specific compliance framework (e.g., CMMC Level 3), the module automatically adjusts applicable cryptographic standards, audit logging granularity, data retention policies, and access controls to ensure strict conformity without manual reconfiguration. This dynamic adaptation ensures the system remains compliant with evolving mandates and diverse regulatory environments.

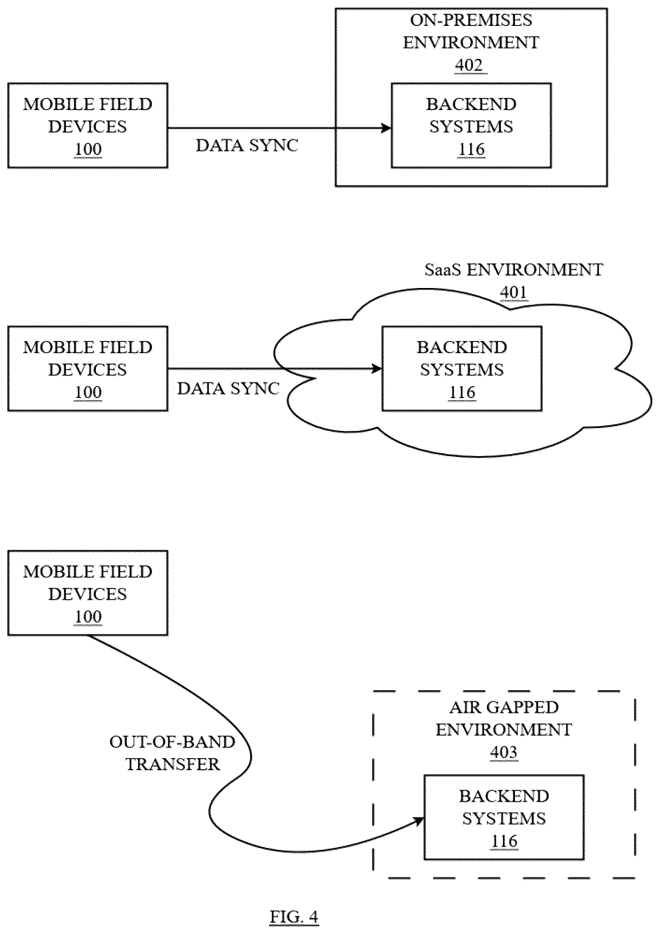

### FIG. 4—Deployment Options

FIG. 4 illustrates the system's flexible deployment options. The system supports a SaaS Environment (401), where Backend Systems (116) and associated services are hosted in the cloud. It also supports an On-premises Environment (402), where Backend Systems (116) are deployed within the operator's private infrastructure. Crucially, the system is also designed for an Air-gapped Environment (403), providing full functionality in isolated, high-security settings where no direct network connectivity exists to external systems. In all deployments, Mobile Field Devices (100) securely interact with Backend Systems (116) either via network or out-of-band transfers as described. It is understood that these deployment options are flexible and interchangeable, allowing the system to be configured to meet varying security postures, regulatory requirements, and operational needs, rather than requiring simultaneous deployment across all environments.

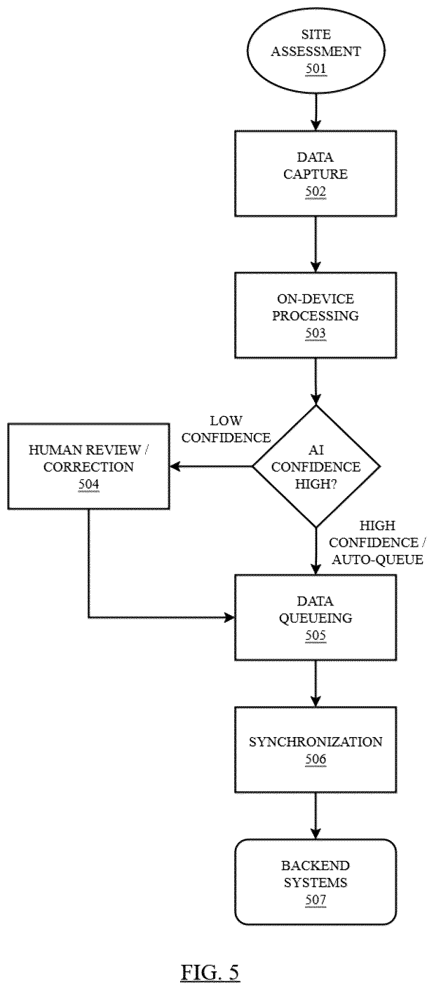

### FIG. 5—Field Workflow Example

FIG. 5 provides a typical field workflow for asset data capture and management. The workflow begins with Site Assessment (501), where a field technician evaluates the operational environment. This is followed by Data Capture (502), where the mobile field device (100)'s sensor (102) captures images or scans of assets. On-Device Processing (503) (utilizing on-device AI model 104) is then performed to extract initial data. The workflow proceeds to Human Review/Correction (504), which corresponds to the human-correction loop (112) (also denoted as 204 in FIG. 2), where operators validate and refine data. After review, data is directed to Data Queueing (505) (corresponding to secure data queue module 114 and 206) for encrypted local storage. Finally, Synchronization (506) (corresponding to data synchronization to backend 208) occurs to transfer the secure data to Backend Systems (507) (corresponding to Backend Systems 116).

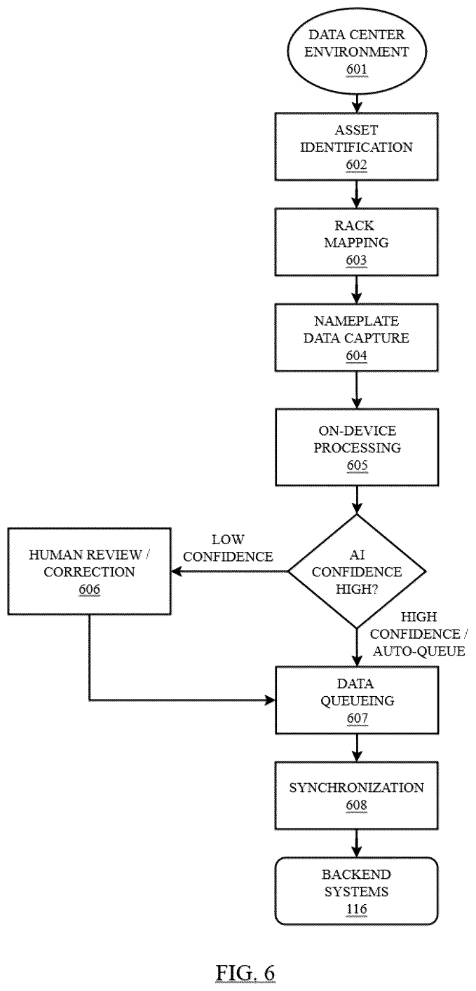

### FIG. 6—Data-Center Workflow

FIG. 6 illustrates a domain-specific deployment of the system, detailing a data-center workflow and specifically showing how the system captures and processes server and equipment data in high-density, secure environments. The process starts within a Data Center Environment (601). This involves Asset Identification (602) and precise Rack Mapping (603) using integrated GPS or GIS APIs. Nameplate Data Capture (604) is performed using the mobile field device (100) to record server nameplates, serials, and model numbers. On-Device Processing (605) (utilizing on-device AI model 104) extracts relevant information from captured data. Following this, the system proceeds to a decision point where it evaluates the AI's confidence in the extracted data and determines if human review is needed. If the AI confidence is high (e.g., meets a configurable threshold), the data bypasses human validation, automatically encrypting and queuing prefilled asset data in Data Queueing (607) (corresponding to secure data queue module 114 and 206) for later synchronization. If the AI confidence is below a critical level, indicating a review is needed, the workflow directs the data to Human Review/Correction (606) (corresponding to human-correction loop 112), where operators validate and refine data. After human correction, the data is then directed to Data Queueing (607) for encrypted local storage. Finally, Synchronization (608) (corresponding to data synchronization to backend 208) occurs to transfer the secure data to Backend Systems (116) for canonical record keeping.

### Adaptive Learning & AI Model Management

The adaptive-learning module, as claimed in claims 11 and 12, supports:

Collection of corrections, annotations, and manual entries for retraining.

Supervised learning on curated datasets of diagrams and asset images.

Transmission of retraining logs (parameters, metrics, correction logs) via TLS 1.3 or post-quantum cryptographic algorithms to Backend Systems (116).

The model synchronization module (119), as claimed in claim 15:

Compares local AI model versions against a signed backend registry (116).

Delivers digitally signed, encrypted model binaries via secure channels or out-of-band transport (e.g., removable media, optical transfer).

Detects unauthorized modifications using cryptographic signatures and hash validation.

Uses dynamically adjustable fallback triggers for low-confidence inference (claim 17).

### Security & Compliance Architecture

### End-to-End Data Protection

Encryption at rest and in transit using AES-256 or stronger standards, with secure transports like TLS 1.3 or quantum-resistant protocols to and from Backend Systems (116).

Public-Key Infrastructure (PKI) for authentication.

Digital signatures for model integrity and provenance verification.

Optional zero-knowledge proofs for privacy-preserving verification, with embodiments excluding this feature.

### Immutable Audit Logging

As shown in FIG. 3 and claimed in claim 8, the immutable-audit-log module records:

All data access and modifications.

AI model update events.

User authentication attempts (successful/failed).

System configuration changes.

Model retraining events.

Immutability is enforced via:

Hash-chaining.

Blockchain-based ledgers.

Write-once, read-many (WORM) storage.

### Air-Gapped Environment Integrity

For air-gapped deployments (claim 14), the system ensures:

Cryptographically verifiable integrity of data packets via hash-validated out-of-band transport.

Use of tamper-evident removable media, secure boot mechanisms, or one-way data diodes.

### Data Center & Government Applications

In data centers or government facilities (FIG. 6, claim 9), the system captures:

Server nameplate data, serials, model numbers.

Rack mapping using precision GPS or GIS APIs.

Blueprint or rack diagram ingestion to pre-populate asset inventories.

Data are encrypted and stored locally with immutable audit logging, ensuring compliance with Backend Systems (116) for:

CMMC for government facilities.

NERC-CIP for utilities.

GDPR for data residency.

Other applicable standards (e.g., SOC 2, ISO 27001, IEC 62443).

The Secure Data Queue Module (114) transmits queued data to Backend Systems (116) via encrypted network channels (e.g., TLS 1.3 or a NIST-approved post-quantum cryptographic algorithm) when connectivity is available, and otherwise via any out-of-band transport (e.g., removable media, secure wired link, optical transfer, or near-field data exchange), with each batch hash-validated to ensure integrity for air-gapped environments. Backend Systems (116) store canonical asset records and immutable audit logs within their infrastructure. Deployment layer supports SaaS, on-premises, and air-gapped environments (illustrated in FIG. 4).

### Threat Model

The system mitigates:

Unauthorized access to field data.

Tampering during transfer, including air-gap bridging.

Model supply chain attacks.

Data eavesdropping or interception.

Insider threats or configuration tampering.

### Advantages

70-90% reduction in manual data entry time.

Up to 90% reduction in transcription errors, per Kim et al. [4].

Enhanced data accuracy via human-in-the-loop validation (claims 1, 13).

Cryptographic agility for evolving compliance.

Support for SaaS, on-premises, and air-gapped operations (claim 1).

Adaptive learning with auditable retraining logs (claims 11, 12).

Security-by-design architecture, unlike bolt-on solutions.

Differentiation from IBM Maximo, SAP Asset Manager, and ABBYY FineReader due to offline AI, air-gapped support, and auditable validation.

Optimized for industrial environments, supporting harsh conditions with ruggedized devices and offline AI processing.

### Practical Implementation Considerations

The system's focus on utilities, industrial facilities, government, and data centers aligns with demand for secure, AI-driven asset management. The 70-90% efficiency claims are compelling for industries with tight budgets and compliance needs. Air-gapped support suits government and defense sectors where cloud solutions are prohibited. Lightweight AI models and optimized hardware configurations ensure cost-effective deployment. The intuitive user interface, featuring touch-based interfaces for rapid validation, and modular training protocols for non-technical field operators maximize adoption and efficiency in harsh environments.

1. A system for secure field data capture and AI-assisted asset management, comprising:
a mobile field device comprising an image-capture subsystem configured to:
obtain equipment images; and
ingest engineering diagrams;
an AI extraction module configured to process the diagrams and images to extract:
asset nomenclature; and
nameplate data;
a human-in-the-loop interface configured to:
enable annotation;
enable validation;
enable location mapping; and
enable manual entry of asset data;
a secure data queue module configured to store encrypted data at rest using:
AES-256; or
a NIST-approved cryptographic standard;
a synchronization module configured to transmit data to a backend database over an encrypted transport selected from:
TLS 1.3; or
a NIST-approved post-quantum cryptographic algorithm; and
non-transitory computer-readable instructions stored on a memory medium, the instructions when executed by at least one processor causing the system to:
support operation in SaaS, on-premises, or air-gapped environments; and
perform dynamic AI model updates.

2. The system of claim 1, wherein the human-in-the-loop interface is delivered via:
augmented reality;
virtual reality; or
mobile device interfaces.

3. The system of claim 1, further comprising a continuous encrypted-backup module configured to:
store data locally; and
synchronize to the backend upon network availability.

4. The system of claim 1, wherein the mobile field device is further configured to:
ingest uploaded engineering diagrams; and
pre-populate asset inventories based on the extracted nomenclature.

5. The system of claim 1, wherein asset-location data are captured via:
integrated GPS; or
GIS APIS;
and linked to a geospatial database within each asset record.

6. A computer-implemented method for secure field data capture and AI-assisted asset management, comprising:
ingesting an engineering diagram via a mobile field device;
extracting asset nomenclature from the diagram using an AI model;
capturing an image of a physical asset;
extracting nameplate data from the image using an AI model;
receiving, via the human-in-the-loop interface:
manual corrections;
asset additions; and
geolocation data;
encrypting and queuing the extracted and corrected data locally using:
AES-256; or
a NIST-approved cryptographic standard; and
synchronizing the queued data to a backend database over an encrypted transport selected from:
TLS 1.3; or
a NIST-approved post-quantum cryptographic algorithm.

7. A non-transitory computer-readable medium storing instructions that, when executed by at least one processor of a mobile field device, cause the processor to:
ingest an engineering diagram via the mobile field device;
extract asset nomenclature from the diagram using an AI model;
capture an image of a physical asset;
extract nameplate data from the image using an AI model;
receive, via a human-in-the-loop interface:
manual corrections;
asset additions; and
geolocation data;
encrypt and queue the extracted and corrected data locally using:
AES-256; or
a NIST-approved cryptographic standard; and
synchronize the queued data to a backend database over an encrypted transport selected from:
TLS 1.3; or
a NIST-approved post-quantum cryptographic algorithm.

8. The system of claim 1, further comprising an immutable-audit-log module configured to record all data access and modifications for compliance with applicable global regulatory and industry-specific standards, including IEC 62443, for utilities, industrial facilities, data centers, and government facilities.

9. The system of claim 1, wherein the mobile field device captures server nameplate data and maps equipment locations within a data center or government facility using integrated GPS or GIS APIs.

10. The system of claim 1, wherein the diagram ingestion and prefill process is performed on:
a workstation;
a remote server; or
a cloud platform,
before transmission of the prefilled asset inventory to the mobile field device.

11. The system of claim 1, further comprising an adaptive-learning module configured to:
update the AI extraction model based on corrections received via the human-in-the-loop interface; and
deploy revised model parameters over-the-air.

12. The system of claim 11, wherein the adaptive-learning module is further configured to:
record retraining data, including:
updated model parameters;
training metrics;
and correction logs; and
transmit the retraining data to the backend database over an encrypted transport selected from:
TLS 1.3; or
a NIST-approved post-quantum cryptographic algorithm.

13. The system of claim 1, wherein the human-in-the-loop interface enables manual addition of assets not identified by the AI extraction module.

14. The system of claim 1, further comprising hash-validated out-of-band transport selected from:
removable media;
secure wired link;
optical transfer; or
near-field data exchange,
for use in air-gapped environments, including government facilities.

15. The system of claim 1, further comprising a model synchronization module configured to:
periodically compare the AI extraction module version on the mobile field device with a backend model registry; and
automatically update the device's model via:
network transport; or
out-of-band transport,
when a newer version is available.

16. The system of claim 1, wherein the AI extraction module employs convolutional neural networks for image-based nameplate data extraction and natural language processing for asset nomenclature extraction from engineering diagrams.

17. The system of claim 1, wherein the fallback AI model is invoked when on-device inference confidence falls below a dynamically adjustable threshold, configurable based on regulatory risk profiles or operational environment.

18. The system of claim 1, wherein the secure data queue module employs dynamic buffer allocation and data prioritization for extended local storage in air-gapped environments.

19. The system of claim 6, further comprising:
automatically encrypting and queuing the extracted and prefilled data in the secure data queue module without receiving manual corrections, asset additions, or geolocation data via the human-in-the-loop interface, when a predetermined confidence threshold for the extracted data is met.

20. The system of claim 1, wherein the AI extraction module employs optical character recognition for nameplate data extraction from equipment images.

21. The system of claim 1, further comprising a compliance adaptation module configured to dynamically select and apply cryptographic algorithms or audit mechanisms based on a plurality of compliance frameworks selected from the group consisting of NERC-CIP, CMMC, GDPR, SOC 2, ISO 27001, and IEC 62443.
